(19) United States
(12) Patent Application Publication
(10) Pub. No.: US 2023/0249329 A1
(43) Pub. Date: Aug. 10, 2023

(54) ADAPTER TOOL WITH MULTIPLE ATTACHMENTS

(71) Applicant: Deone Lashawne Chapman, Fredericksburg, VA (US)

(72) Inventor: Deone Lashawne Chapman, Fredericksburg, VA (US)

(21) Appl. No.: 18/097,462

(22) Filed: Jan. 16, 2023

Related U.S. Application Data
(63) Continuation-in-part of application No. 15/619,873, filed on Jun. 12, 2017.
Application No. 15/619,873 is a continuation-in-part of application No. 14/740,893, filed on Jun. 16, 2015, now Pat. No. 9,707,676.
(60) Provisional application No. 62/012,847, filed on Jun. 16, 2014.

(30) Foreign Application Priority Data
Aug. 30, 2022 (EM) 00916010400010011

(51) Int. Cl. B25F 1/02; B25F 1/00

(52) U.S. Cl. CPC B25F 1/02; B25F 1/006

(57) ABSTRACT

An adapter tool comprising a head having a main head body extending along a first axis from a first main body end to a second main body end, a first slot therebetween and a tool attachment end. A handle comprising an elongated body having a top end defining a handle post is received within the first slot and a bottom end having a grip. A plurality of tool attachments each comprising a tool attachment proximal side with a head attachment slot recessed therein and a tool attachment distal side defining a tool portion. A selective securing of tool attachments to the tool attachment ends configures the adaptor tool into one of a plurality of configurations. A mounting of a blade between an upper adapter type of tool attachment and the grip in open position or a lower adapter configures the adapter tool as a hacksaw.

### REFERENCE TO RELATED APPLICATIONS

This application is a continuation-in-part of U.S. Non-Provisional Pat. Application Ser. No. 15/619,873, filed Jun. 12, 2017, which is a continuation-in-part of U.S. Non-Provisional Application Ser. No. 14/740.893, filed Jun. 16, 2015. now is U.S. Pat. No. 9,707,676 issued on Jul. 18, 2017, and claims the benefit of priority of U.S. Provisional Application No. 62/012,847, filed Jun. 16, 2014, each of which is herein incorporated by reference

### FIELD OF THE INVENTION

The present invention relates to hand tools. More particularly, the present invention is related to multi-purpose hand tools with interchangeable tool elements.

### BACKGROUND OF THE INVENTION

In manufacturing, repair, maintenance and overhaul jobs more than one type of tool is needed. Accordingly, people are required to buy and carry different types of tools to complete such tasks. Many multi-purpose tools have been introduced over the years that involve multiple, interchangeable parts designed to be used with one unit to provide both flexibility and convenience all in one portable unit. However, most of these tools are complicated, difficult to manufacture, and difficult to use.

Therefore, there exists a need for a multi-purpose tool which overcomes the a fore-mentioned drawbacks.

### OBJECTS OF THE INVENTION

An object of the present invention is to provide a tool that can be assembled into multiple configurations for various uses.

Another object of the present invention is to provide an inexpensive multi-purpose tool.

Yet another object of the present invention is to provide a portable, easy-to-use multi-purpose tool.

A further object of the present invention is to provide a multi-purpose tool which can be used as a hacksaw/saw.

A still further object of the present invention is to provide a robust and durable multi-purpose tool.

Another object of the present invention is to provide a tool having multiple weight adjustment options.

These as well as other objects of the present invention are apparent upon inspection of this specification, including the drawings and appendices attached hereto.

### SUMMARY OF THE INVENTION

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The present invention is directed to an adapter tool having different parts which can be assembled in different combinations to configure the apparatus into various types of tools such as different hammers and hacksaws/saws, for example. The adapter tool comprises a head, a handle and a plurality of attachments. The head has a main head body extending along a first axis from a first main body end to a second main body end, at least one tool attachment end extending outwardly substantially along the first axis from the first main body end or from the second main body end and a first slot disposed along a second axis substantially perpendicular to the first axis between the first main body end and the second main body end. The handle comprises an elongated body having a top end and a bottom end opposite to the top end along a longitudinal axis of the handle. The top end defines a handle post configured to be received within the first slot and the bottom end has a grip. Each of the plurality of tool attachments comprises a tool attachment body having a tool attachment proximal side with a head attachment slot recessed into a head mating end of the tool attachment proximal side and a tool attachment distal side which defines a tool portion. The tool attachment proximal side has one or more tool apertures which open into the head attachment slot.

Any one or more of the plurality of tool attachments can be secured to the tool attachment ends by inserting one or more fasteners through the one or more tool apertures to configure the adaptor tool into a desired tool configuration. The grip comprises one or more lower adapter slots disposed substantially perpendicular to the longitudinal axis of the handle These adapter slots are disposed aligned to one or more lower adapter openings provided on the bottom end of the handle. A blade can be mounted between a first type upper adapter, which is one of the plurality of the tool attachments, and a lower adapter attached to the lower adapter slot(s) to configure the adapter tool as a first type of hacksaw. The lower adapter has a lower adapter proximal end which can be a fork-shaped structure with two distally apart arms or can be a single arm structure. These fork(s)/arm(s) are received by the adapter slots. A distal end of the lower adapter is configured to hold other end of the blade for the hacksaw/saw configuration. It may be noted that other suitable attachments can also be attached to the lower slots to create different tool configurations.

In another embodiment, the grip is pivotally mounted on the handle for movement from a closed position in which a longitudinal axis of the grip remains substantially in line with the longitudinal axis of the handle to an open position in which the longitudinal axis of the grip remains substantially perpendicular to the longitudinal axis of the handle The grip is made pivotable around a pivot axis perpendicular to the longitudinal axis of the handle and the pivot axis passes through a handle lower opening disposed on a bare handle bottom side of the handle and through a pivot side of the grip opposite to a grip upper side of the grip. A locking mechanism comprising a rotatable grip upper lock and a rotatable grip lower lock is provided for releasably locking the grip in the closed position and in the open position as required. Each of the rotatable grip lower lock and the rotatable grip upper lock comprises a spindle, a spring and a knob housed in a lock housing disposed in the grip body. In the closed position, the spindle of the grip lower lock engages a first notch disposed on the bare handle bottom side spaced apart from the handle lower opening, and the spindle of the grip upper lock engages a middle opening disposed in the bare handle bottom side spaced apart from the first notch of the bottom end for the releasable locking of the grip. In the open position, the spindle of the grip lower lock engages a second notch disposed on the bare handle bottom side spaced apart from the handle lower opening and from the first notch for the releasable locking. A blade can be mounted between a second type upper adapter chosen from the plurality of tool attachments and the grip in open position to configure the adapter tool as a second type of hacksaw/saw.

To the accomplishment of the foregoing and related ends, certain illustrative aspects of the disclosed invention are described herein in connection with the following description and the annexed drawings These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

In order to describe the manner in which features, and other aspects of the present disclosure can be obtained, a more particular description of certain subject matter will be rendered by reference to specific embodiments which are illustrated in the appended drawings. Understanding that these drawings depict only typical embodiments and are not therefore to be considered limiting in scope, nor drawn to scale for all embodiments, various embodiments will be described and explained with additional specificity and detail through the use of the accompanying drawings in which:

FIG. 1A is an exploded perspective view of the handle and head of the adapter tool in accordance with an embodiment of the present embodiment;

FIGS. 1B-1D are front perspective, side and top views respectively of the head of the adapter tool in accordance with an embodiment of the present embodiment;

FIGS. 1E-1G are side, front perspective and front views respectively of the handle of the adapter tool in accordance with an embodiment of the present embodiment;

FIGS. 2A-2E are top, bottom, front, right side and left side views respectively of a nail puller type of tool attachment of the adapter tool in accordance with an embodiment of the present embodiment:

FIGS. 2F-2J are left side, bottom, right side, front and top views respectively of an axe type of tool attachment of the adapter tool in accordance with an embodiment of the present embodiment;

FIGS. 2K-2O are left side, bottom side, right side, front and top views respectively of a weight type/weighted hammer type of tool attachment of the adapter tool in accordance with an embodiment of the present embodiment:

FIGS. 3A-3D are exploded view, perspective view, front view and left side view respectively of the adapter tool having weight type/weighted hammer type and nail puller type of tool attachments in accordance with an embodiment of the present embodiment;

FIGS. 4A-4D are perspective view, right side view, top view and front view respectively of an upper adapter type of tool attachment in accordance with an embodiment of the present embodiment:

FIGS. 4E-4G are perspective view, top view and front view respectively of a lower adapter type of tool attachment having fork-shaped arms at the lower adapter proximal end in accordance with an embodiment of the present embodiment:

FIG. 4H illustrates a perspective view of a lower adapter type of tool attachment having a single arm at the lower adapter proximal end in accordance with an embodiment of the present invention;

FIG. 5A is a front view of the adapter tool with a nail puller type of tool attachment on one side of the head and a hacksaw affixed between an upper and lower adapter on the opposite side in accordance with an embodiment of the present embodiment;

FIG. 5B is an exploded view of the adapter tool with an upper adapter type of tool attachment, a blade and a lower adapter in accordance with an embodiment of the present embodiment:

FIGS. 6A-6B illustrate a side and a top views of the adapter tool having a head attached to a bare handle;

FIG. 6C illustrates a side view of the adapter tool comprising a rotatable grip with exploded view of a grip upper lock;

FIG. 6D illustrates a side view of the adapter tool comprising a rotatable grip in locked closed condition;

FIG. 6E illustrates an enlarged view of the grip upper lock of the handle as illustrated in FIG. 6D and identified as detail 6E in FIG. 6D;

FIG. 7A illustrates a front view of the adapter tool comprising a rotatable grip in the locked closed condition:

FIG. 7B illustrates a front view of the adapter tool comprising a rotatable grip in locked open condition; and

FIG. 7C illustrates a front view of the adapter tool configured to act as a hacksaw/saw with the help of the rotatable grip.

### DETAILED DESCRIPTION OF THE INVENTION

The following description is presented to enable any person skilled in the art to make and use the invention and is provided in the context of particular applications of the invention and their requirements. Various modifications, for example but not limited to changes made to ease manufacturing, to the disclosed embodiments will be readily apparent to those skilled in the art and the general principles defined herein may be applied to other embodiments and applications without departing from the scope of the present invention. Thus, the present invention is not intended to be limited to the embodiments shown but is to be accorded the widest scope consistent with the principles and features disclosed herein.

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as not to obscure the present invention.

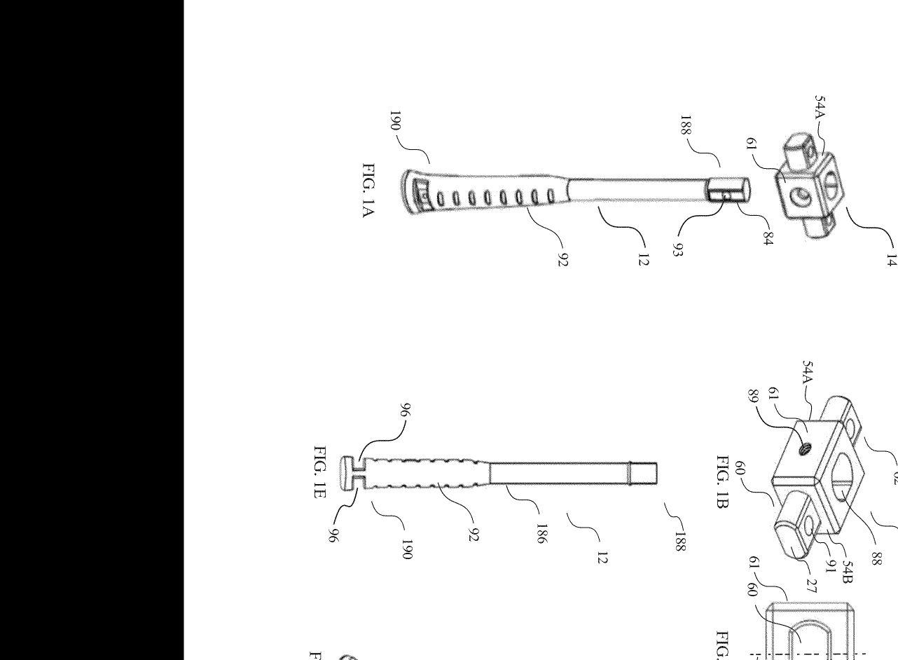

Reference to FIGS. 1A-1G, 2A-2O, 3A-3D and 5A-5B, the adapter tool 10 of the present invention comprises an elongated handle 12, a head 14 and one or more attachments 25 (25A, 25B, 25C, 25D and 25E etc. for example). The head 14 comprises a main head body 61 extending along a first axis 150 from a first main body end 54A to a second main body end 54B. at least a tool attachment end (such as first tool attachment end 60 and/or a second tool attachment end 62) extending outwardly substantially along the first axis 150 from the first main body end 54A and/or the second main body end 54B and a first slot 88 disposed along a second axis 152 substantially perpendicular to the first axis 150 between the first main body end 54A and the second main body end 54B. The tool attachment end 54 (54A and 54B) is so shaped and dimensioned that the cross-sectional area of at least its distal end 27 is less than the cross-sectional area of the main head body 61 on a plane perpendicular to the first axis 150. Optionally, one or more second slots 89 may be disposed on the main head body 61 in such a way that the aperture of the one or more second slots 89 open at the aperture of the first slot 88. Further, in some embodiments, one or more head end apertures/opening 91 are disposed on the first tool attachment end 60 and second tool attachment end 62. The handle 12 comprises an elongated body 186 having a top end 188 opposite to a bottom end 190 along a handle longitudinal axis 155. In some embodiments, the head 14 may be integral to the handle 12 whereas in certain other embodiments, the head 14 and the handle 12 are releasably attachable. For the embodiments in which the handle 12 and the head 14 are releasably attachable, a handle post 84 configured to be received within the first slot 88 is disposed at the top end 188 of the handle 12. A handle post opening 93 is provided at the handle post 84 which gets aligned with the second slot 89 when the handle post 84 receives the head 14. The opening/apertures/slot 89 and the handle post opening 93 can be made threaded or non-threaded. Accordingly, a threaded fastener 26 (such as a bolt or screw, for example) or a non-threaded fastener 26 (such as pins, for example) can be used for securing the head 14 to the handle 12. In either case, a fastener 26 can be made to go all the way through the apertures or openings or can be inserted only partially. In some embodiments, the head 14 can be pressed fit over the handle post 84 i.e. by way of an interference fit achieved by forcing the head 14 under pressure into the handle post 84 with the slot 88 aligned with the post 84 having a slightly bigger size than the slot 88

A substantial part of the bottom end 190 of the handle 12 is configured to be a grip 92. For this, in one embodiment, an ergonomic grip may be secured over the handle 12 to act as the grip 92 or the bottom end 190 may be dimensioned itself to act as the grip 92. The grip 92 provides additional comfort and absorbs shock. The handle 12 including the grip 92 of the present invention may be made of metal, fiberglass, wood, plastic or the like. The purpose of the grip 92 is to provide additional comfort and/or act as a lower adapter and/or to facilitate attachment of a lower adapter to the handle 12. The grip 92 comprises a gripping surface 94 formed on the grip 92 and one or more lower adapter slots 96 disposed substantially perpendicular to the handle longitudinal axis 155. The lower adapter slots 96 are disposed aligned to lower adapter opening 98 provided on the bottom end 190 of the handle 12 as depicted in FIGS. 1A, 1E, 1F and 1G. The gripping surface 94 may be formed of rubber or a like elastomeric material, or of a hard plastic or metal as desired.

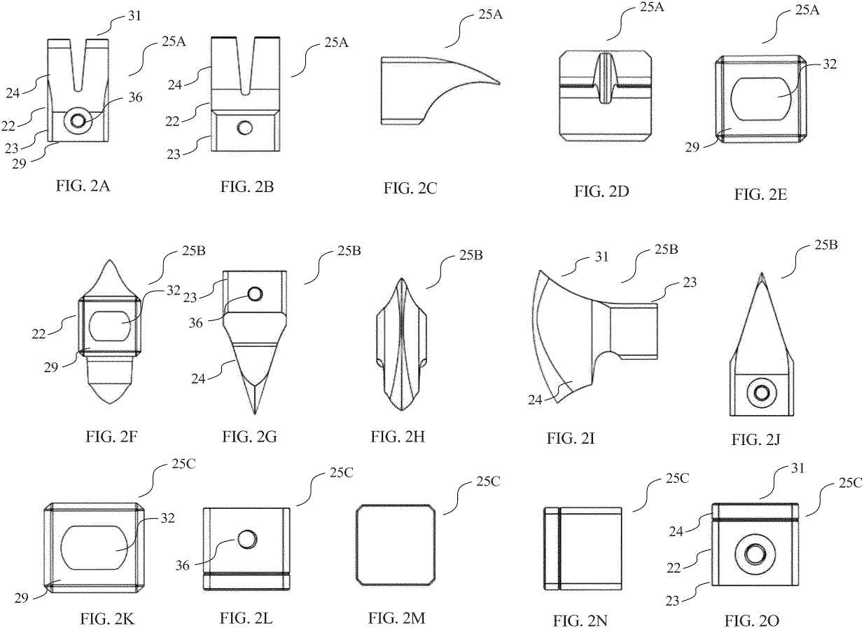

Reference to FIGS. 2A-2O, the present invention further comprises a plurality of tool attachments 25 (25A, 25B, 25C, 25D and 25E etc.). Each of the tool attachments 25 (25A. 25B, 25C, 25D and 25E etc.) comprises a tool attachment body 22 having a tool attachment proximal side 23 and a tool attachment distal side 24 substantially opposite to said proximal end 23. The tool attachment proximal side 23 comprises a head mating end 29 defining a head attachment slot 32 recessed into the head mating end 29. A tool portion 31 is disposed on the distal end 24. The recessed head attachment slot 32 extends from the head mating end 29 toward the tool portion 31 and is shaped and dimensioned to slidably receive therein the tool attachment end 54 of the head 14. Tool aperture 36 (threaded or non-threaded) disposed on the tool proximal side 23 opens into the head attachment slot 32. The tool aperture/opening 36 is so positioned that, when the tool attachment 25 is removably attached to the tool attachment end 60 or 62. the tool aperture 36 lies aligned with the head end aperture 91. Then, a threaded fastener 26 (such as a bolt or screw, for example) or a non-threaded fastener 26 (such as pins, for example) can be used for securing the tool attachment 25 to the tool attachment ends 60 and/or 62 of the head 14. The head 14 and tool attachments 25 may be made of a metal or any other solid material as per requirement. When attached, the head 14 interface with the tool attachments 25 for even force distribution which enables better shock absorption. The edges 33 of the main head body 61. the distal end 27 of the tool attachment ends 60 and 62 and the corresponding portions of the tool attachment 25 (such as the face and inner side of the head attachment slot 32) may be beveled to prevent mushrooming. The beveled edges of the tool attachment 25 and those of the head 14 complement each other so that the outer surfaces of the tool attachment 25 and the head 14 lie flush with each other when attached together to further align the head 14 and the attachments tool attachment ends 60, 62 having a substantially rounded rectangular cross-section on a plane perpendicular to the first axis 150 as shown in FIGS. 1B and 1C provide greater strength against distortion. Reference to FIGS. 2E, 2F and 2K, the cross-section of the head attachment slot 32 of the tool attachments 25A on a plane parallel to the head mating end 29 is also similarly generally rounded rectangular in shape.

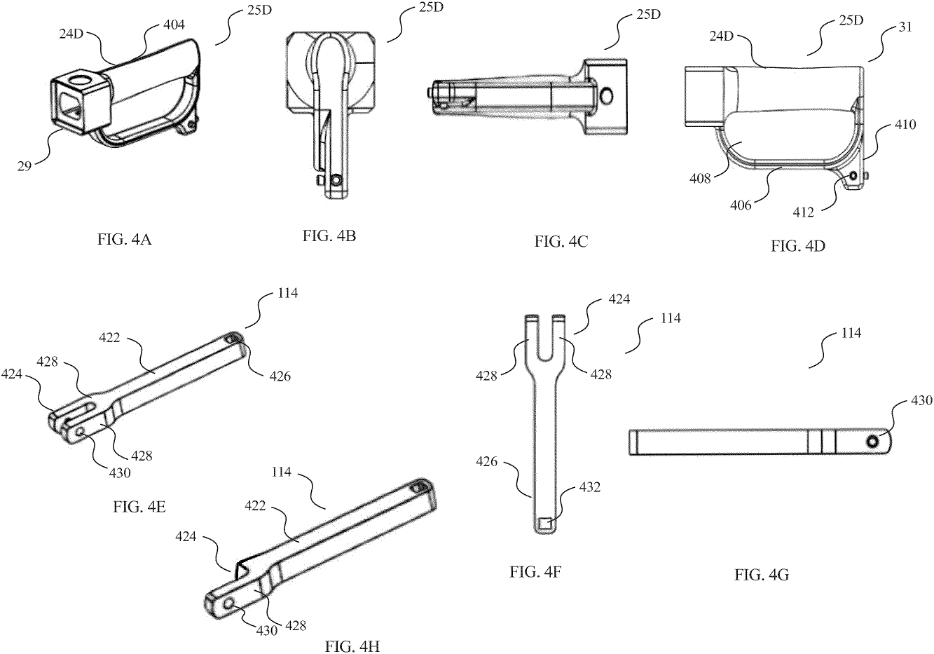

Reference to FIGS. 2A, 2I, 2O, 4D and 7C, the tool portion 31 provides the functionalities of different types of tools. Accordingly, different tool attachments 25 may be alternatively connected to the head 14 to form different tools. FIGS. 2A-2E illustrate a nail puller type tool attachment whereas FIGS. 2F-2J illustrate an axe type tool attachment 25B, FIGS. 2K-2O illustrate an adjustable weight type tool attachment 25C and FIGS. 4A- 4D illustrate a first type upper adapter type tool attachment 25D. The tool attachments can be of different weights. Particularly, tool attachment 25C of varying weights can be used to make the adapter tool 10 a striking tool of required weight as per need. The tool attachment 25C and head 14 may be combined to create different tool heads with certain weight, such as 12 oz (ounce), 16 oz, 24 oz. 28 oz, 32 oz and 38 oz hammers. 3 lb sledgehammer. 5 lb sledge hammer, multiple weight ball pein hammer and other tool heads with specific weight. For example, a lighter weight tool adapter 10 will be appropriate for a 16 oz hammer, whereas a heavier weight striking adapter tool 10 will be appropriate for a 28 oz hammer. Having a striking adapter tool 10 of appropriate weight allows more force to be transmitted to the object on which strike is made By letting a user adjust the weight of the adapter tool 10 as per the need, in addition to making the tool suitable for any specific work, the life of the tool 10 gets extended and the job becomes less strenuous for the user.

Reference to FIGS. 4A-4D, the first type of upper adapter 25D comprises a tool portion 24D having an upper hand grip 404 extending distally from the head mating end 29, an upper hand grip guard 406 spaced distally relative to the upper hand grip 404 and defining a grip aperture 408 there between, and an upper blade mount 412 (such as a hook, for example) disposed on the upper hand grip 404 or on the upper hand grip guard 406 for mounting thereto one end of a blade/saw 122.

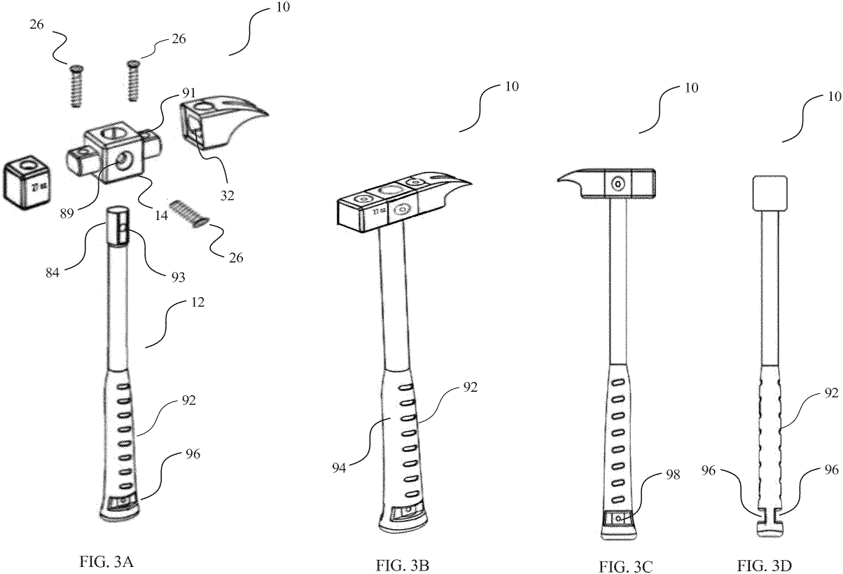

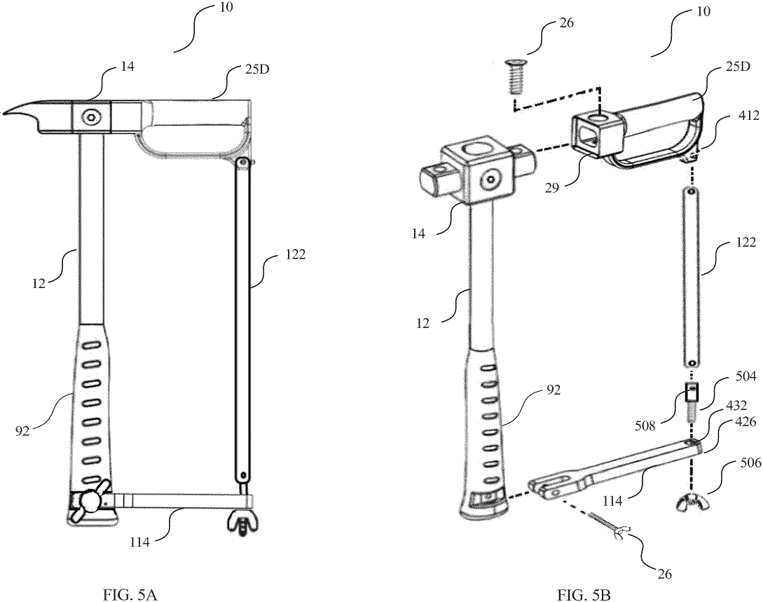

To hold the other end of a blade, a lower adapter 114 is provided as illustrated in FIGS. 4E-4G and 5A-5B. The lower adapter 114 comprises an elongated lower adapter body 422 having a lower adapter proximal end 424 and a lower adapter distal end 426. The lower adapter proximal end 424 can be a fork-shaped structure with two distally apart forks/arms 428, as shown in FIGS. 4E-4F, which are configured to be received in the one or more lower adapter slots 96 provided on one side or on either side of the handle bottom end 190 or the lower adapter proximal 424 can have only a single arm 428 as shown in FIG. 4H. Two coaxial lower adapter proximal end openings 430 are disposed on the forks 428 (only one opening 430 in case of single arm version as in FIG. 4H)). The openings 98 in FIG. 3C and 430 in FIG. 4G can be made threaded or non-threaded. Accordingly, a threaded fastener 26 (such as a bolt or screw, for example) or a non-threaded fastener 26 (such as pins, for example) can be used to non-pivotally secure the lower adapter 114 to the handle 12. The lower adapter distal end 426 is configured to hold one end of the blade 122 with the help of a blade tensioning system.

The adapter tool 10 can be configured to become different types of hacksaws or saws. The terms hacksaw or saw are used herein to include different kinds of saw such as coping saw, bow cut saw and fret saw etc. For example, FIG. 5A illustrates the adapter tool 10 configured as a first type of hacksaw/saw. FIG. 5B depicts an exploded view of the same. A blade tensioning system comprising a threaded fastener 504 (a bolt, for example) having a lower blade mount 508, and an adjuster 506 (a wing nut, for example) is provided for adjusting the tension applied to the blade 122 mounted to the blade mounts 412 and 508. The fastener 504 is inserted through an aperture 432 disposed in the lower adapter distal end 426. Even though the blade tensioning system is shown disposed on the lower adapter 114, the same can be disposed on the upper adapter 25D also. In assembled condition, rotation of the adjuster 506 increases or decreases tension in the blade/saw 122 held between the mounts 412 and 508.

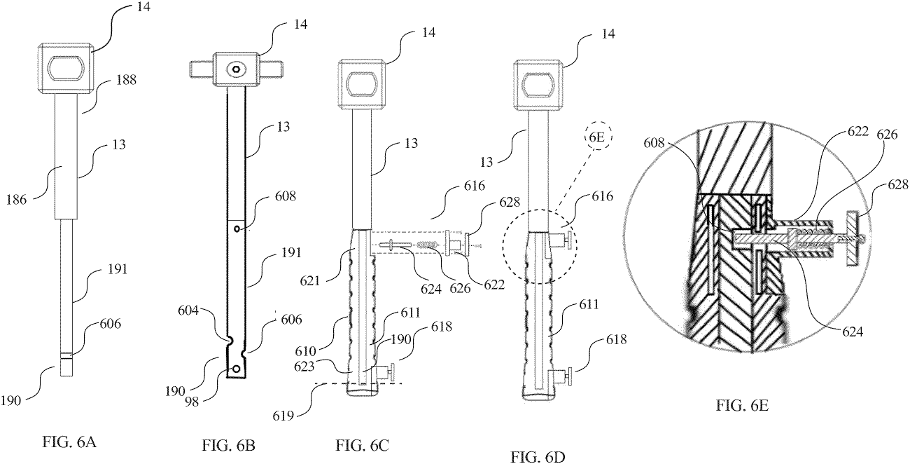

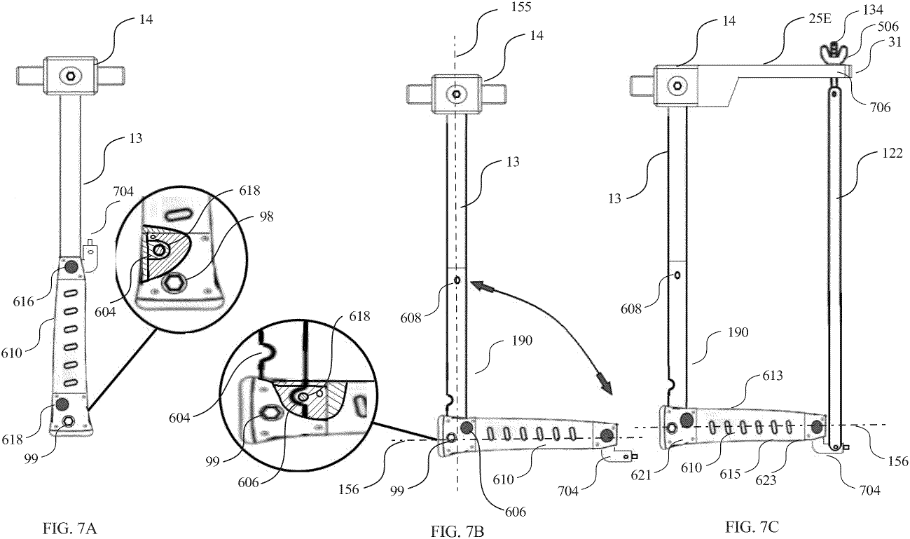

In another embodiment, the grip 92 on the handle can be configured as a rotatable handle 610 which acts as a lower adapter instead of having a separate lower adapter 114. FIGS. 6A-6E and 7A-7B illustrate such an embodiment. In this embodiment, either the bottom end 190 of the elongated body 186 of the handle 13 is shaped and dimensioned to be a bare handle bottom side 191 to receive a rotatable grip 610 as shown in FIGS. 6A-6E and 7A-7B, or the bottom end 190 of the elongated body 186 of the embodiment illustrated in FIGS. 3A-3D is kept unaltered and the rotatable grip 610 is shaped and dimensioned to fit into/over the bottom end 190.

As shown in FIG. 6B, one or more grooves or notches 604 and 606 are disposed on the bare handle bottom side 191 spaced apart from each other and peripherally away from the handle lower opening 98. One or more middle apertures/openings 608 are also provided in the bottom side 191 spaced apart from the handle lower opening 98 and also from the notches 604 and 606. The first notch 604 and the second notch 606 are positioned substantially diagonally opposite to each other. Reference to FIGS. 6C-6E, the grip 610 is pivotally mounted on the handle 13 for movement from a folded/closed position (as in FIGS. 6C, 6D and 7A) in which the longitudinal axis 156, shown in FIG. 7B, of the grip 610 remains substantially in line with the longitudinal axis 155 of the handle 13 to an unfolded/open position (as in FIGS. 7B and 7C) in which the longitudinal axis 156 of the grip 610 remains substantially perpendicular to the longitudinal axis 155 of the handle 13. Reference FIG. 6C, FIG. 6B and FIG. 7B, the grip 610 is made pivotable around the axis 619 passing through the handle lower opening 98 by inserting a pin 99 or other similar peg or bolt through coaxial openings provided on the pivot side 623 of the grip 610. The grip 610 is configured to have a space adapted to be at least partially received longitudinally by the bottom end 190 when the grip 610 is in its folded position as in FIGS. 6C and 6D. In folded/closed position, grip 610 acts like a gripping area as is done by grip 92 in FIG. 3B. Reference FIG. 6C and FIG. 7B, the grip 610 comprises a grip body 611 having a grip upper side 621 and a grip pivot side 623 opposite to the grip upper side 621 along the grip longitudinal axis 156. The grip body 611 has an open front side 613 along the longitudinal axis 156 and a closed back side 615 opposite to the front side 613 as shown in FIG. 7C. Reference FIG. 6C and FIG. 7C the grip body 611 is so configured that when the grip 610 is pivoted about the pivot axis 619 from an unfolded position to a folded position, the bottom end 190 enters the grip body 611 from the front side 613 and occupies the space provided between the front side 613 and back side 615 staying substantially flush or inward of the front side 613. +

Reference to FIGS. 6C-6E and 7A-7B a locking mechanism comprising a rotatable grip upper lock 616 and a rotatable grip lower lock 618 is provided for releasably locking the grip 610 in its extended/unfolded/open position and also in its folded/closed position. Each of the rotatable lower and upper locks 616 and 618 comprises a spindle 624, a spring 626 and a knob 628 housed in a lock housing 622 disposed in the grip body 611. In an engaged position of the locking mechanism, as depicted in FIGS. 6D-6E and 7A-7B, the spindle 624 engages the middle opening 608 and/or the notches 604 or 606, as the case may be, and stays that way biased by the spring 626. To disengage the locking mechanism, the spindle 624 is pulled out manually with the help of knob 628.

Reference to FIGS. 6A-6E and FIGS. 7A-7C, when the grip 610 is in folded condition to act as a gripping surface/area, the upper lock 616 stays engaged with the middle opening 608 (shown in FIG. 6E) and the lower lock 618 stays engaged with the first notch 604 (shown in FIG. 7A). This locking arrangement ensures that no matter how much moment of force or torque or linear displacement force is exerted on the grip 610, it stays there firmly as the grip 610 is locked at both of its extremities. To make the grip 610 a lower adapter, the locks 616 and 618 are disengaged and the grip 610 is unfolded pivotally around pin 99 and brought to a substantially perpendicular position with respect to the longitudinal axis 155 of the handle 13. The grip 610 is then locked at this unfolded condition by engaging the lower lock 618 with the second notch 606 as shown in FIG. 7B. An upper adapter 25D (first type of upper adapter) tool attachment as shown in FIGS. 5A-5B or an equivalent tool attachment such as a second type of upper adapter 25E. as shown in FIG. 7C, is attached to the head 14. A blade or saw 122 can then be mounted between the upper blade mount 706 and lower blade mount 704 (in case of upper adapter 25E) or between upper blade mount 412 and lower blade mount 704 (in case of use of upper adapter 25D). The tool adapter 10 is now ready to be used as a second type of hacksaw/saw

The present invention may be used as a survival tool for those that enjoy camping and hunting. The present invention may also be used by carpenters, gardeners, campers, metal workings, archeologists, engineers, machinists, welders, survivalists, miners, mechanists, craftsmen, construction workers, and an everyday handy man and do it yourselfer. There can also be a toy version of the invention for kids made from any material.

It is specifically intended that the present invention not be limited to the embodiments and illustrations contained herein and the claims should be understood to include modified forms of those embodiments including portions of the embodiments and combinations of elements of different embodiments as come within the scope of the following claims.

1. An adapter tool comprising:
a head comprising a main head body extending along a first axis from a first main body end to a second main body end, at least one tool attachment end extending outwardly substantially along said first axis from said first main body end or from said second main body end and a first slot disposed along a second axis substantially perpendicular to said first axis between said first main body end and said second main body end:
a handle comprising an elongated body having a top end and a bottom end opposite to said top end along a longitudinal axis of said handle, said top end defining a handle post configured to be received within said first slot and said bottom end having a grip disposed therein: and
a plurality of tool attachments, each of said plurality of tool attachments comprising a tool attachment body having a tool attachment proximal side with a head attachment slot recessed into a head mating end of said tool attachment proximal side and a tool attachment distal side defining a tool portion, said tool attachment proximal side having one or more tool apertures opening into said head attachment slot;
wherein a selective securing of at least one of said plurality of tool attachments to at least one of said tool attachment ends by inserting one or more fasteners through said one or more tool apertures configures said adaptor tool into one of a plurality of configurations.

2. The adapter tool as in claim 1, wherein said grip comprises one or more lower adapter slots disposed substantially perpendicular to said longitudinal axis of said handle, said one or more lower adapter slots being disposed aligned to one or more lower adapter openings provided on said bottom end.

3. The adapter tool as in claim 2, wherein a mounting of a blade between a first type upper adapter and a lower adapter configures said adapter tool as a first type of hacksaw in said one of said plurality of configurations, said first type upper adapter being one of said plurality of tool attachments having said tool portion configured to hold one end of said blade and said lower adapter having a lower adapter proximal end configured to be received by said one or more lower adapter slots and a lower adapter distal end configured to hold other end of said blade for said mounting.

4. The adapter tool as in claim 3, wherein said first type upper adapter comprises an upper hand grip extending distally from said head mating end, an upper hand grip guard spaced distally relative to said upper hand grip defining a grip aperture therebetween and an upper blade mount disposed on said upper hand grip or on said upper hand grip guard for said mounting of said blade.

5. The adapter tool as in claim 1, wherein said plurality of tool attachments include a plurality of adjustable weight type tool attachments configured to add varying weights to said adapter tool with said selective attachment to at least said one of said tool attachment ends.

6. The adapter tool as in claim 1, wherein said grip is pivotally mounted on said handle for movement from a closed position in which a longitudinal axis of said grip remains substantially in line with said longitudinal axis of said handle to an open position in which said longitudinal axis of said grip remains substantially perpendicular to said longitudinal axis of said handle, said grip being pivotable around a pivot axis perpendicular to said longitudinal axis of said handle and passing through a handle lower opening disposed on a bare handle bottom side of said handle and through a pivot side of said grip opposite to a grip upper side of said grip.

7. The adapter tool as in claim 6, wherein a locking mechanism comprising a rotatable grip upper lock and a rotatable grip lower lock is provided for a releasable locking of said grip in said closed position and in said open position, each of said rotatable grip lower lock and said rotatable grip upper lock comprises a spindle, a spring and a knob housed in a lock housing disposed in said grip body.

8. The adapter tool as in claim 7, wherein in said closed position said spindle of said grip lower lock engages a first notch disposed on said bare handle bottom side spaced apart from said handle lower opening, and said spindle of said grip upper lock engages a middle opening disposed in said bare handle bottom side spaced apart from said first notch of said bottom end for said releasable locking.

9. The adapter tool as in claim 8, wherein in said open position said spindle of said grip lower lock engages a second notch disposed on said bare handle bottom side spaced apart from said handle lower opening and from said first notch for said releasable locking.

10. The adapter tool as in claim 9, wherein a mounting of a blade between a second type upper adapter and said grip in open position configures said adapter tool as a second type of hacksaw/saw in said one of said plurality of configurations, said second type upper adapter being one of said plurality of tool attachments having said tool portion configured to hold one end of said blade.

11. The adapter tool as in claim 1, wherein a cross-sectional area of at least a distal end of said at least one tool attachment end is less than a cross-sectional area of said main head body on a plane perpendicular to said first axis.

12. The adapter tool as in claim 1, wherein said at least one tool attachment comprises one or more head end apertures disposed on said at least one tool attachment end, said one or more head end apertures are configured to be engaged by said one or more fasteners inserted through said one or more tool apertures.

13. The adapter tool as in claim 1, wherein said main head body further comprises one or more second slots between said first main body end and said second main body end such that said one or more second slots open at an aperture of said first slot, said one or more slots being configured to align with a handle post opening disposed on said handle post when said handle post is received within said first slot.

14. The adapter tool as in claim 1, wherein said tool attachment is configured to have a substantially rounded rectangular cross-section on a plane perpendicular to said first axis.

15. The adapter tool as in claim 1, wherein said first main body end, said second main body end, said at least one tool attachment end and said head mating end are configured to have a beveled edge.

16. The adapter tool as in claim 3, wherein said lower adapter proximal end is configured to have a fork-shaped structure with two distally apart arms or a to have a single arm.
